(19) United States
(12) Patent Application Publication
(10) Pub. No.: US 2024/0252920 A1
(43) Pub. Date: Aug. 1, 2024

(54) METHOD AND APPARATUS FOR DISPLAYING GAME INTERFACE, AND DEVICE AND STORAGE MEDIUM THEREOF

(71) Applicant: NETEASE (HANGZHOU) NETWORK CO., LTD., Hangzhou, Zhejiang (CN)

(72) Inventors: Shihan HU, Hangzhou, Zhejiang (CN); Jiayao LI, Hangzhou, Zhejiang (CN)

(73) Assignee: NETEASE (HANGZHOU) NETWORK CO., LTD., Hangzhou, Zhejiang (CN)

(21) Appl. No.: 18/561,006

(22) PCT Filed: Jan. 18, 2022
(86) PCT No.: PCT/CN2022/072490

§ 371 Date: Nov. 15, 2023

(30) Foreign Application Priority Data
May 26, 2021 (CN) 202110579140.9

(51) Int. Cl. A63F 13/5255; A63F 13/63

(52) U.S. Cl. CPC A63F 13/5255; A63F 13/63; A63F 2300/308

(57) ABSTRACT

A method and apparatus for displacing a game interface, a device and a storage medium are provided. A graphical user interface is provided by a terminal device, the graphical user interface includes a game image captured by a virtual camera, the game image includes a virtual object, and the method includes: in response to a configuration trigger operation for the virtual object, shortening a distance between the virtual camera and the virtual object, and displacing a function control for configuring the virtual object; and configuring content corresponding to the function control for the virtual object in response to a selection operation for the function control.

### CROSS-REFERENCE TO RELATED APPLICATIONS

The present disclosure is a U.S. National Stage Application of International Application No. PCT/CN2022/072490, filed on Jan. 18, 2022, which is based upon and claims priority to Chinese Patent Application No. 202110579140.9, filed on May 26, 2021, entitled “GAME INTERFACE DISPLAY METHOD AND APPARATUS, AND DEVICE AND MEDIUM”, the entire content of both of which are incorporated herein by reference for all purposes.

### TECHNICAL FIELD

The present disclosure relates to a field of game technology, and more particularly to a method and apparatus for displaying a game interface, a device and a medium.

### BACKGROUND

In game applications, a game interface is the basis of human-computer interaction, there are usually many controls displayed, and a user may click on a control in the game interface to jump from a current game interface to a game interface corresponding to the control.

However, a current game interface switching mode is relatively simple and rigid, and a sense of the interface switching is obvious and not smooth enough, which is easy to interrupt the user's flow, thus affecting the game experience.

### SUMMARY

According to an aspect, the present disclosure provides a method for displaying a game interface, where a graphical user interface is provided by a terminal device, the graphical user interface includes a game image captured by a virtual camera, where the game image includes a virtual object, and the method includes:
in response to a configuration trigger operation for the virtual object, shortening a distance between the virtual camera and the virtual object, and displaying a function control for configuring the virtual object; and
configuring content corresponding to the function control for the virtual object in response to a selection operation for the function control.

According to another aspect, the present disclosure provides a terminal device, including a memory, a processor and a computer program stored on the memory and executable by the processor, when the computer program is executed by the processor, the processor is configured to:
provide a graphical user interface, wherein the graphical user interface comprises a game image captured by a virtual camera, wherein the game image comprises a virtual object;
in response to a configuration trigger operation for the virtual object, shorten a distance between the virtual camera and the virtual object, and display a function control for configuring the virtual object; and
configure content corresponding to the function control for the virtual object in response to a selection operation for the function control.

According to another aspect, the present disclosure provides a non-transitory computer-readable storage medium, where the computer-readable storage medium stores computer instructions, and the computer instructions, when executed by a processor, cause the processor to:
in response to a configuration trigger operation for the virtual object, shorten a distance between a virtual camera and a virtual object, and display a function control for configuring the virtual object; and
configure content corresponding to the function control for the virtual object in response to a selection operation for the function control.

### BRIEF DESCRIPTION OF THE DRAWINGS

The accompanying drawings described herein are used for providing a further understanding of the present disclosure, and constitute a part of the present application, and the exemplary embodiments of the present disclosure and the description thereof are used for explaining the present disclosure, but do not constitute improper limitations to the present disclosure. In the drawings:

FIG. 1 is a schematic flow diagram of an overview of a method for displaying a game interface in some embodiments of the present disclosure;

FIG. 2a is a schematic diagram of an interface when a user selects a hero avatar in some embodiments of the present disclosure;

FIG. 2b is a schematic diagram of an interface of a game application in response to a selection operation of a hero avatar in some embodiments of the present disclosure;

FIG. 2c is a schematic diagram of an interface when a user triggers a hero configuration in some embodiments of the present disclosure;

FIG. 2d is a schematic diagram of an interface when a game application hides first interface information in some embodiments of the present disclosure;

FIG. 2e is a schematic diagram of an interface of a game application in response to triggering a hero configuration operation in some embodiments of the present disclosure;

FIG. 2f is another schematic diagram of an interface of a game application in response to triggering a hero configuration operation in some embodiments of the present disclosure;

FIG. 2g is a schematic diagram of an interface when a game application displays a target layer in some embodiments of the present disclosure;

FIG. 2h is a schematic diagram of an interface when a game application displays a return control in some embodiments of the present disclosure;

FIG. 2i is a schematic diagram of an interface when a game application displays second interface information in some embodiments of the present disclosure;

FIG. 3 is a specific flow diagram of a method for displaying a game interface in some embodiments of the present disclosure;

FIG. 4 is a schematic diagram of a functional structure of an apparatus for displaying a game interface in some embodiments of the present disclosure;

FIG. 5 is a schematic diagram of a hardware structure of a terminal device in some embodiments of the present disclosure.

### DETAILED DESCRIPTION

In order to make the objects, technical solutions and beneficial effects of the present disclosure clearer, technical solutions in embodiments of the present disclosure are clearly and completely described in the following with reference to the accompanying drawings in the embodiments of the present disclosure. Apparently, the described embodiments are merely some rather than all of the embodiments of present disclosure. All other embodiments obtained by a person of ordinary skill in the art based on the embodiments of present disclosure without making creative efforts shall fall within the protection scope of present disclosure.

In order to facilitate better understanding of the present disclosure by those skilled in the art, the technical terms involved in the present disclosure are briefly introduced first in the following.
1. A terminal device refers to a front-end device running game software, including but not limited to a mobile phone, a computer, a Personal Digital Assistant (PDA), a smart TV, and the like.
2. A graphical user interface refers to an interface that uses graphics and/or characters on a game screen to display various types of controls such as a function control and a return control.
3. A virtual object refers to a fictional image with personalized characteristic in a game screen. For example, the virtual object may be a virtual character in the game screen.
4. Interface information refers to information displayed in a graphical user interface. In the present disclosure, the interface information includes first interface information and second interface information, where:
the first interface information includes object configuration information displayed on the graphical user interface before a configuration trigger operation is performed on the virtual object in the game screen. Specifically, the object configuration information includes but is not limited to any one or combination of the following: a virtual object control, a virtual object configuration control, current configuration information and object introduction information of a virtual object, and the like;
the second interface information includes function configuration information displayed on the graphical user interface after a configuration completion operation is performed on the virtual object in the game screen. Specifically, the function configuration information includes but is not limited to configured content information of the virtual object.
5. Virtual camera refers to a fictitious camera that captures game images from different scenes and/or different perspectives in a game application.

It should be noted that, the terms “first,” “second”, and the like in the present disclosure are used for distinguishing between similar elements and not necessarily for describing a particular sequential or chronological order. It will be appreciated that the used expressions may be interchanged under appropriate circumstances such that the embodiments described herein may be implemented in other sequences than those illustrated or described herein. In addition, “and/or” used in the present disclosure describes the association relationship of associated objects, indicating that there may be three relationships, for example, A and/or B, which may indicate: A exists alone, A and B exist simultaneously, and B exists alone. The character “/” generally indicates that the associated objects are in an “or” relationship.

Having introduced the technical terms involved in the present disclosure, the application scenarios and design ideas for embodiments of the present disclosure are briefly described in the following.

Currently, in many game applications, a user may click on a control in the game interface to jump from a current game interface to a game interface corresponding to the control, the newly displayed game interface is usually not associated with the original game interface, which realizes the jumping and switching of the entire game interface. For example, the user may select a virtual object in the game interface for selecting the virtual object, and click on a virtual object configuration control in the game interface for selecting the virtual object, so as to jump from the game interface for selecting the virtual object to a game interface for configuring the virtual object. A current game interface switching mode is relatively simple and rigid, and a sense of the interface switching is obvious and not smooth enough, which is easy to interrupt the user's flow, thus affecting the game experience.

To this end, in some embodiments of the present disclosure, in response to a configuration trigger operation for the virtual object, a distance between the virtual camera and the virtual object is shortened, and a function control for configuring the virtual object is displayed, and in response to a selection operation for the function control, a skill or a skin corresponding to the function control is configured for the virtual object. In this way, by shortening the distance between the virtual camera and the virtual object and displaying the function controls for configuring the virtual object in response to the configuration trigger operation for the virtual object, it is possible to create a visual effect that achieves interface switching in the process of zooming in the virtual object, which enriches the interface switching mode, achieves a smooth interface switching display, thereby reducing the interruption of the user's flow, increasing a sense of game immersion and improving the user experience.

Having introduced the application scenarios and design ideas of the embodiments of the present disclosure, the technical solutions provided by the embodiments of the present disclosure are described in detail below.

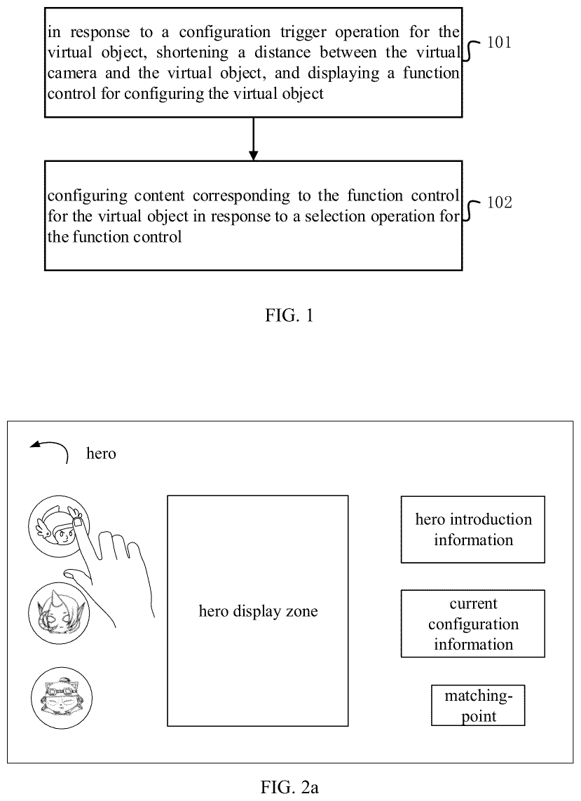

Some embodiments of the present disclosure provides a method for displaying a game interface, which may be applied to a game application, where the game application provides a graphical user interface through a terminal device, the graphical user interface includes a game image captured by a virtual camera, and the game image includes a virtual object, as shown in FIG. 1, a general flow of the method for displaying the game interface provided by the embodiment of the present disclosure includes steps 101 and 102:

in step 101: in response to a configuration trigger operation for the virtual object, a distance between the virtual camera and the virtual object is shortened, and a function control for configuring the virtual object is displayed.

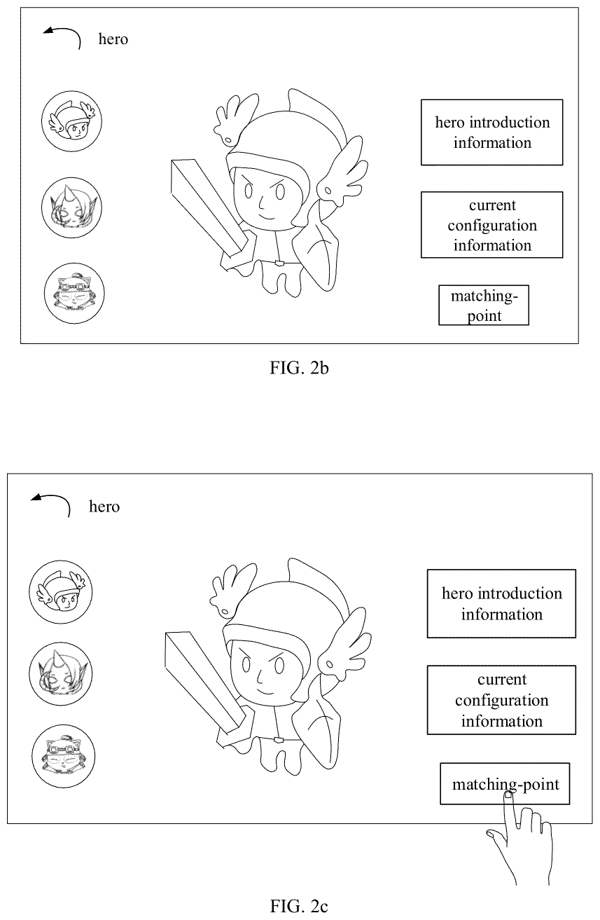

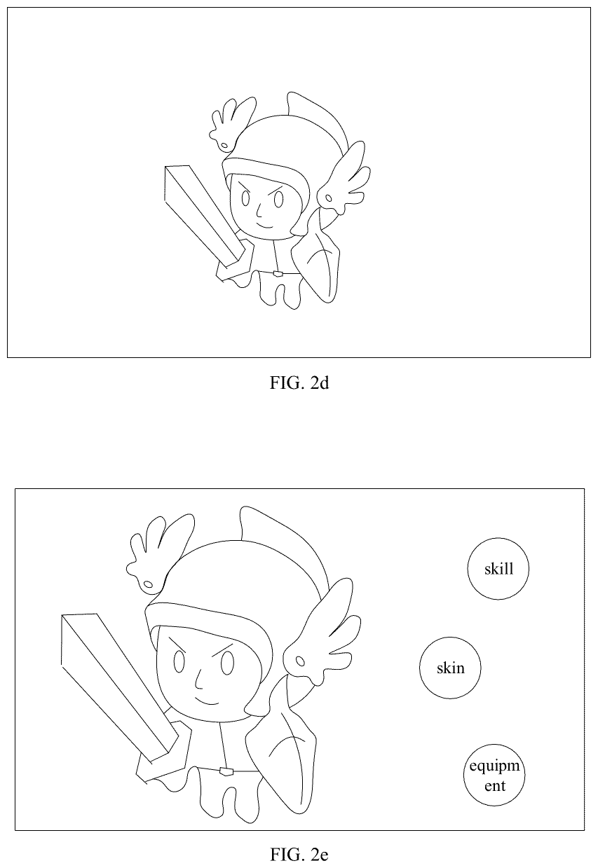

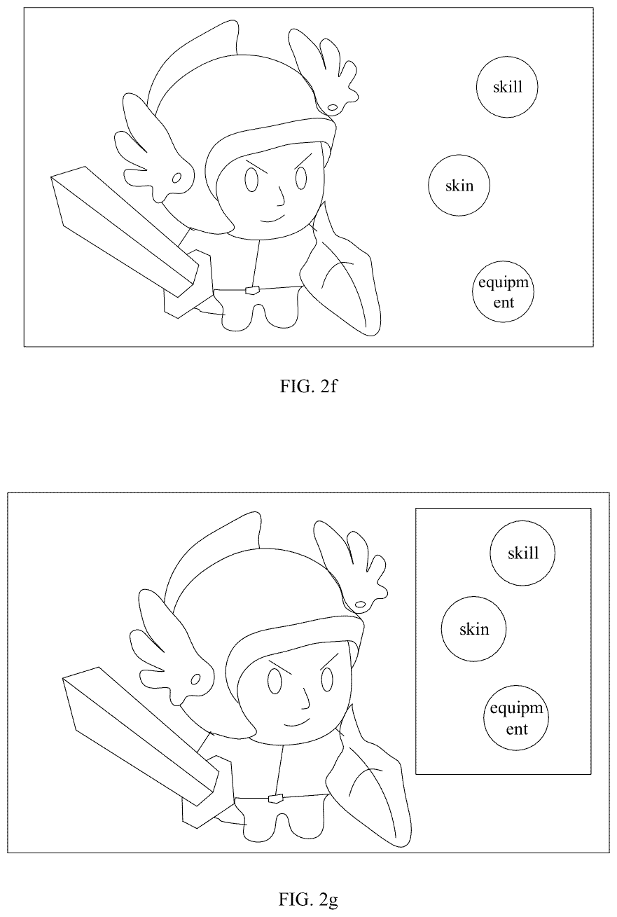

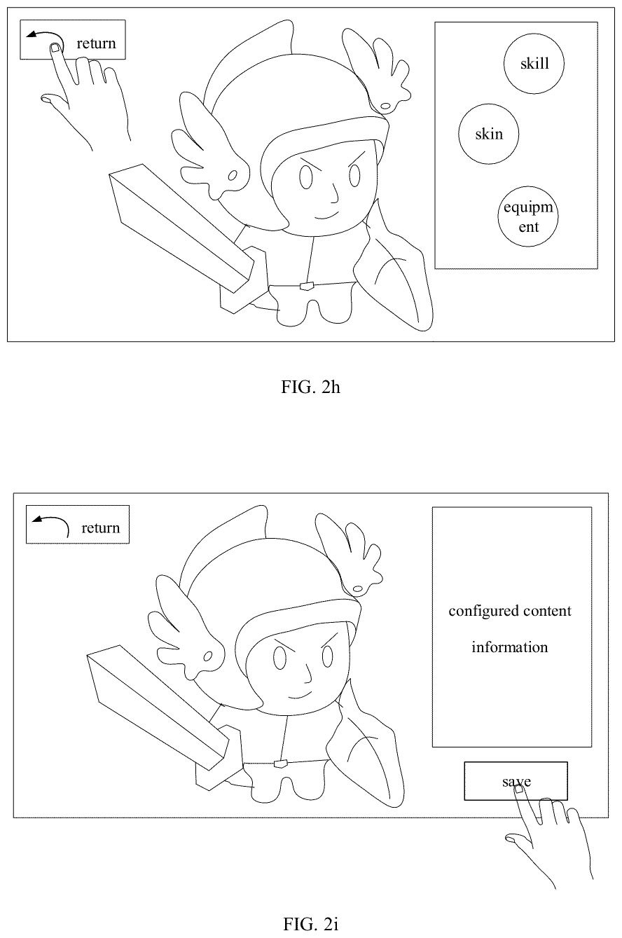

In practical applications, the user may select the virtual object by performing a selection operation on a virtual object control included in the graphical user interface for selecting the virtual object. For example, as shown in FIG. 2a, the user may select a hero by performing a selection operation on a hero avatar included in a hero interface for selecting heroes.

In the specific implementation, in response to a selection operation for a virtual object control, the game application displays a virtual object represented by the virtual object control, current configuration information and object introduction information of the virtual object. For example, as shown in FIG. 2b, in response to the selection operation for the hero avatar included in the hero interface, the game application displays the hero corresponding to the hero avatar, the current configuration information and the hero introduction information of the hero.

Further, the users may perform the configuration trigger operation (such as a click operation) on the virtual object configuration control included in the graphical user interface for selecting the virtual object, to trigger the content configuration of the virtual object. For example, as shown in FIG. 2c, the user may also perform the click operation on the virtual object configuration control (such as a matching-point control or a dressing control included in the hero interface), to trigger the content configuration of the hero.

In practical applications, in order to make the interface switching display smoother and more fluent, in some embodiments of the present disclosure, the user may perform the configuration trigger operation on the virtual object configuration control included in the graphical user interface for selecting the virtual object, after the content configuration of the virtual object is triggered, and before the game application responds to the configuration trigger operation for the virtual object, the first interface information may be hidden. That is, the object configuration information, such as the virtual object configuration control, the current configuration information and the object introduction information of the virtual object, the virtual object control included in the graphical user interface for selecting the virtual object, may be hidden. For example, as shown in FIG. 2d, before the game application responds to the click operation for the virtual object configuration control (such as the matching-point control or the dressing control included in the hero interface), the object configuration information, such as the virtual object configuration control (such as the hero avatar, the matching-point control or the dressing control included in the hero interface), the hero introduction information and the current configuration information, may be hidden.

In the specific implementation, in some embodiments, in response to the configuration trigger operation for the virtual object, the game application may shorten the distance between the virtual camera and the virtual object, and display the function control for configuring the virtual object, that is, when the game application responds to the configuration trigger operation for the virtual object, by shortening the distance between the virtual camera and the virtual object and displaying the function control for configuring the virtual object, it is possible to create a visual effect that achieves the interface switching in the process of zooming in and displaying the virtual object, so as to achieve the smooth interface switching display. For example, as shown in FIG. 2e, the game application responds to the click operation for the virtual object configuration control (such as the matching-point control or the dressing control included in the hero interface), by gradually shortening the distance between the virtual camera and the hero, the hero is gradually zoomed in and displayed, and in the process of zooming in and displaying the hero, the function control for configuring the hero (such as a skill control, an equipment control, a skin control and the like) is displayed.

In another embodiment, in order to achieve a better visual effect, in response to the configuration trigger operation for the virtual object, the game application may also control the virtual camera to rotate a preset angle towards a preset direction. For example, as shown in FIG. 2f, the game application responds to the click operation for the virtual object configuration control (such as the matching-point control or the dressing control included in the hero interface), by gradually shortening the distance between the virtual camera and the hero, the hero is gradually zoomed in and displayed, while zooming in the hero, the virtual camera may be controlled to rotate a preset angle towards right, such that the hero turns the preset angle to the left side; during the hero is zoomed in and is rotated to left at the preset angle, the function control for configuring the hero (such as a skill control, an equipment control, a skin control and the like) is displayed.

In some embodiments of the present disclosure, the game application may respond to the configuration trigger operation for the virtual object, may also shorten the distance between the virtual camera and the virtual object, and display a target layer, where the function control is located on the target layer, and the target layer is transparent. For example, as shown in FIG. 2g, the game application responds to the click operation for the virtual object configuration control (such as the matching-point control or the dressing control included in the hero interface), by gradually shortening the distance between the virtual camera and the hero, the hero is gradually zoomed in and displayed, and in the process of zooming in and displaying the hero, a transparent target layer is displayed, the target layer may cover the game screen. The function control for configuring the hero (such as a skill control, an equipment control, a skin control and the like) and the hero are located on the target layer, or the hero may be not located on the target layer, and only the function control is placed on the target layer.

In addition, in some embodiments of the present disclosure, the game application may also display a return control while displaying the function control for configuring the virtual object. Further, the user may perform a trigger operation (such as a click operation) on the return control, so as to return the user graphical interface for selecting the virtual object. For example, as shown in FIG. 2h, the game application may display the return control while displaying the function control for configuring the hero (such as a skill control, an equipment control, a skin control and the like), the user may perform the click operation on the return control, so as to return the hero interface for selecting the hero.

In the specific implementation, in some embodiments, in response to the trigger operation for the return control, the game application may hide the function control, and lengthen the distance between the virtual camera and the virtual object. That is, when the game application responds to the trigger operation for the return control, by lengthening the distance between the virtual camera and the virtual object and hiding the function control, it is possible to create a visual effect that achieves the interface switching in the process of zooming out and displaying the virtual object, so as to achieve the smooth interface switching display. For example, the game application responds to the click operation for the return control, by gradually lengthening the distance between the virtual camera and the hero, the hero is gradually zoomed out and displayed, and in the process of zooming in the hero, the function control for configuring the hero (such as a skill control, an equipment control, a skin control and the like) is hidden, so as to return to the hero interface as shown in FIG. 2d.

In another embodiment, in response to the trigger operation for the return control, the game application may hide the function control, lengthen the distance between the virtual camera and the virtual object, and control the virtual camera to rotate a preset angle towards a direction opposite to the preset direction. For example, the game application responds to the click operation for the return control, by gradually lengthening the distance between the virtual camera and the hero, the hero is gradually zoomed out and displayed, while zooming out the hero, the virtual camera may be controlled to rotate a preset angle towards left, such that the hero turns the preset angle to the right side; during the hero is zoomed out and rotated to right at the preset angle, the function control is hidden, so as to return to the hero interface as shown in FIG. 2d.

In step 102: in response to a selection operation for the function control, content corresponding to the function control is configured for the virtual object.

In practical applications, the user may configure the content corresponding to the function control for the virtual object by performing the selection operation on the function control, where the content corresponding to the function control includes at least one of the following: a skill, equipment or a skin. For example, the user may configure the skill corresponding to the skill control for the hero by performing the selection operation on the skill control; the user may also configure the equipment corresponding to the equipment control for the hero by performing the selection operation on the equipment control; the user may also configure the skin corresponding to the skin control for the hero by performing the selection operation on the skin control.

Further, the user may also perform the trigger operation (such as a click operation) on a configuration completion control, to trigger and complete the configuration for the virtual object. In response to a configuration completion operation for the virtual object, the game application displays a second interface information on the graphical user interface, i.e., configured content information of the virtual object. For example, as shown in FIG. 2i, the user may perform the click operation on the configuration completion control (such as a save control, a wear control and the like), to trigger and complete the configuration for the virtual object, and in response to the click operation on the configuration completion control (such as the save control, the wear control and the like), the game application determines that the configuration for hero is complete, and displays the configured content information of the hero.

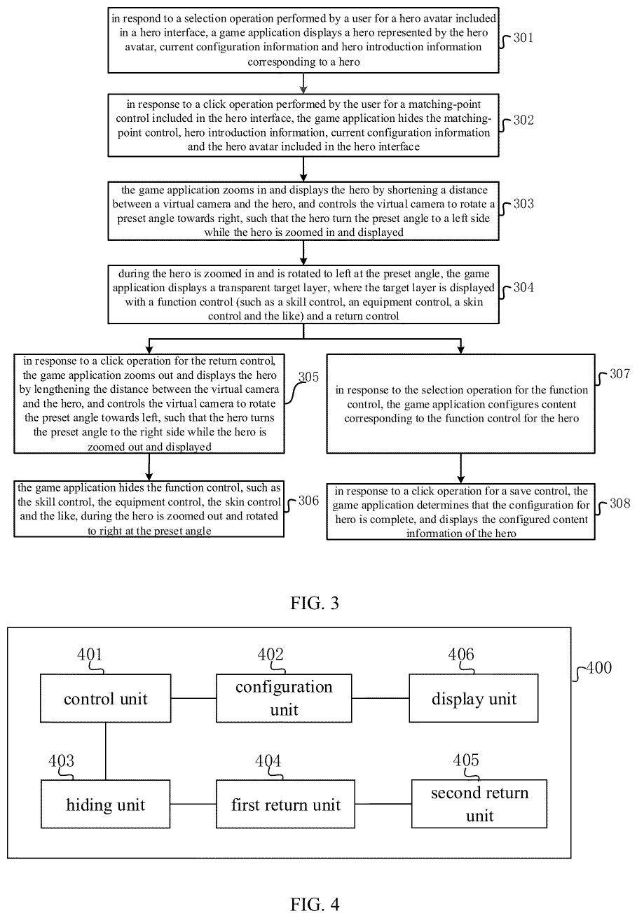

The following is a detailed description of the method for displaying the game interface provided by the embodiments of the present disclosure, using specific application scenarios, as shown in FIG. 3, and the specific flow of the method for displaying the game interface provided by the embodiments of the present disclosure is as follows:

In step 301: in respond to a selection operation performed by a user for a hero avatar included in a hero interface, a game application displays a hero represented by the hero avatar, current configuration information and hero introduction information corresponding to a hero.

In step 302: in response to a click operation performed by the user for a matching-point control included in the hero interface, the game application hides the matching-point control, hero introduction information, current configuration information and the hero avatar included in the hero interface.

In step 303: the game application zooms in and displays the hero by shortening a distance between a virtual camera and the hero, and controls the virtual camera to rotate a preset angle towards right, such that the hero turn the preset angle to a left side while the hero is zoomed in and displayed.

In step 304: during the hero is zoomed in and is rotated to left at the preset angle, the game application displays a transparent target layer, where the target layer is displayed with a function control (such as a skill control, an equipment control, a skin control and the like) and a return control.

In step 305: in response to a click operation for the return control, the game application zooms out and displays the hero by lengthening the distance between the virtual camera and the hero, and controls the virtual camera to rotate the preset angle towards left, such that the hero turns the preset angle to the right side while the hero is zoomed out and displayed.

In step 306: the game application hides the function control (such as the skill control, the equipment control, the skin control and the like) during the hero is zoomed out and rotated to right at the preset angle.

In step 307: in response to the selection operation for the function control, the game application configures content corresponding to the function control for the hero.

In step 308: in response to a click operation for a save control, the game application determines that the configuration for hero is complete, and displays the configured content information of the hero.

Based on the above embodiments, the embodiments of the present disclosure provide an apparatus for displaying a game interface, where a graphical user interface is provided by a terminal device, the graphical user interface includes a game image captured by a virtual camera, where the game image includes a virtual object, as shown in FIG. 4. The apparatus 400 for displaying the game interface provided by the embodiments of the present disclosure at least includes:
a control unit 401, configured to in response to a configuration trigger operation for the virtual object, shorten a distance between the virtual camera and the virtual object, and display a function control for configuring the virtual object;
a configuration unit 402, configured to configure content corresponding to the function control for the virtual object in response to a selection operation for the function control.

In some embodiments, the content corresponding to the function control includes at least one of the following: a skill, equipment or a skin.

In some embodiments, the control unit 401 is further configured to:
in response to the configuration trigger operation for the virtual object, control the virtual camera to rotate a preset angle towards a preset direction.

In some embodiments, the control unit 401 is further configured to:
in response to the configuration trigger operation for the virtual object, display a target layer, where the function control is located on the target layer, and the target layer is transparent.

In some embodiments, the graphical user interface also includes first interface information before the control unit 401 responds to the configuration trigger operation for the virtual object;
the apparatus 400 for displaying the game interface provided by the embodiments of the present disclosure also includes:
a hiding unit 403, configured to hide the first interface information in response to the configuration trigger operation for the virtual object.

In some embodiments, the control unit 401 is further configured to display a return control while displaying the function control for configuring the virtual object;
the apparatus 400 for displaying the game interface provided by the embodiments of the present disclosure also includes:
a first return unit 404, configured to, after the control unit 401 displays the function control for configuring the virtual object, in response to a trigger operation for the return control, hide the function control and lengthen the distance between the virtual camera and the virtual object.

In some embodiments, the control unit 401 is also configured to display a return control while displaying the function control for configuring the virtual object;
the apparatus 400 for displaying the game interface provided by the embodiments of the present disclosure further includes:
a second return unit 405, configured to, after the control unit 401 displays the function control for configuring the virtual object, in response to a trigger operation for the return control, hide the function control; lengthen the distance between the virtual camera and the virtual object, and control the virtual camera to rotate a preset angle towards a direction opposite to the preset direction.

In some embodiments, the apparatus 400 for displaying the game interface provided by the embodiments of the present disclosure also includes:
a display unit 406, configured to, after the configuration unit 402 configures the content corresponding to the function control for the virtual object, in response to a configuration completion operation for the virtual object, display second interface information on the graphical user interface, where the second interface information includes configured content information of the virtual object.

It should be noted that the principle of solving technical problems of the apparatus 400 for displaying the game interface provided by the embodiments of the present disclosure is similar to that of the method for displaying the game interface provided by the embodiments of the present disclosure. Thus, the implementation of the apparatus 400 for displaying the game interface provided by the embodiments of the present disclosure may be referred to the implementation of the method for displaying the game interface provided by the embodiments of the present disclosure, and the repetition will not be repeated.

Having described the method and the apparatus for displaying the game interface provided by the embodiments of the present disclosure, the terminal device provided by the embodiments of the present disclosure is briefly described next.

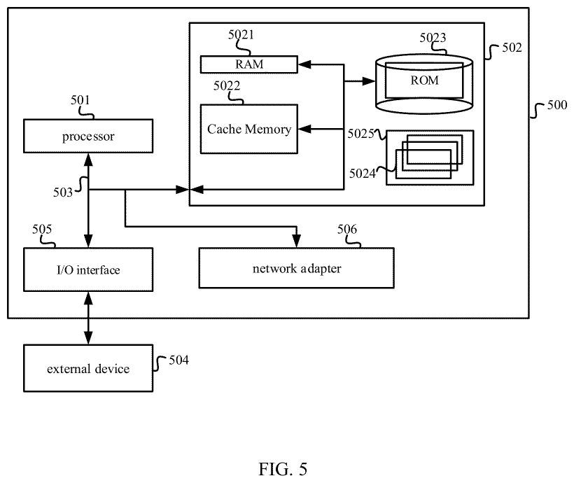

Referring to FIG. 5, the terminal device 500 provided by embodiments of the present disclosure includes at least: a processor 501, a memory 502 and computer programs stored on the memory 502 and executable on the processor 501. The processor 501 implements the method for displaying the game interface provided by embodiments of the present disclosure when executing the computer programs.

It should be noted that the terminal device 500 shown in FIG. 5 is merely an example and should not bring any limitation to the functions and usage scope of the embodiments of the present disclosure.

The terminal device 500 provided by embodiments of the present disclosure may also include a bus 503 connecting different components, including the processor 501 and the memory 502. The bus 503 represents one or more of several types of bus structures, including a memory bus, a peripheral bus, a local area bus, and the like.

The memory 502 may include readable media in the form of volatile memory, such as Random Access Memory (RAM) 5021 and/or Cache Memory 5022, and may further include Read Only Memory (ROM) 5023.

The memory 502 may also include a program tool 5025 having a set (at least one) of program modules 5024, the program modules 5024 including, but not limited to: an operating subsystem, one or more applications, other program modules, and program data. Each of these examples or some combination may include an implementation of a network environment.

The terminal device 500 may also communicate with one or more external devices 504 (e.g., keyboard, remote control, etc.), may also communicate with one or more devices that enable the user to interact with the terminal device 500 (e.g., mobile phone, computer, etc.), and/or, may communicate with any device that enables the terminal device 500 to communicate with one or more other terminal devices 500 (e.g., router, modem, etc.). This communication may be via Input/Output (I/O) interface 505. Besides, the terminal device 500 may communicate with one or more networks (e.g., Local Area Network (LAN), Wide Area Network (WAN), and/or public networks, such as the Internet) via the network adapter 506. As shown in FIG. 5, the network adapter 506 communicates with other modules of the terminal device 500 via the bus 503. It should be understood that, although not shown in FIG. 5, other hardware and/or software modules may be used in conjunction with the terminal device 500, including but not limited to: microcode, device drives, redundant processors, external disk drive arrays, Redundant Arrays of Independent Disks (RAID) subsystems, tape drives, and data backup storage subsystems, etc.

The non-transitory computer readable storage medium provided by embodiments of the present disclosure is described below. The computer readable storage medium provided by embodiments of the present disclosure stores computer instructions that, when executed by a processor, implement the method for displaying the game interface provided by embodiments of the present disclosure. Specifically, the computer instructions may be installed in the terminal device 500, such that the terminal device 500 may implement the method for displaying the game interface provided by embodiments of the present disclosure by executing the installed computer instructions.

In addition, the method for displaying the game interface provided by embodiments of the present disclosure may also be implemented as a program product, which includes a program code for causing the terminal device 500 execute the method for displaying the game interface provided by embodiments of the present disclosure when the program product is run on the terminal device 500.

The program product provided by embodiments of the present disclosure may adopt any combination of one or more readable media. The readable media may be a readable signal medium or a readable storage medium. The readable storage medium may be, but not limited to, an electrical, magnetic, optical, electromagnetic, infrared, or semiconductor system, apparatus or device, or any combination of the above. Specifically, more specific examples (a non-exhaustive list) of readable storage media include: an electrical connection with one or more wires, a portable disk, a hard disk, a RAM, a ROM, an erasable programmable read only memory (EPROM), an optical fiber, a portable Compact Disc Read-Only Memory (CD-ROM), an optical storage device, a magnetic storage device, or any combination thereof.

The program product provided by embodiments of the present disclosure may adopt CD-ROM and include program codes, and may also be run on a computing device. However, the program products provided by the embodiments of the present disclosure are not limited to this. In the embodiments of the present disclosure, the readable storage medium may be any tangible medium containing or storing a program, which may be used by or in combination with an instruction execution system, apparatus or device.

It should be noted that although several units or sub-units of the apparatus are mentioned in the above detailed description, this division is only exemplary and not mandatory. Actually, according to the embodiment of the present disclosure, the features and functions of two or more units described above may be embodied in one unit. On the contrary, the features and functions of one unit described above may be further divided into a plurality of units to be embodied.

Furthermore, although the operations of the disclosed method are described in a specific order in the drawings, this does not require or imply that these operations must be performed in this specific order, or that all the illustrated operations must be performed to achieve the desired results. Additionally or alternatively, some steps may be omitted, a plurality of steps may be combined into one step for execution, and/or one step may be decomposed into a plurality of steps for execution.

Although the preferred embodiments of the present disclosure have been described, those skilled in the art may make additional changes and modifications to these embodiments once they know the basic inventive concepts. Therefore, the appended claims are intended to be interpreted as including the preferred embodiments and all changes and modifications that fall within the scope of the present disclosure.

According to an aspect, embodiments of the present disclosure provide a method for displaying a game interface, where a graphical user interface is provided by a terminal device, the graphical user interface includes a game image captured by a virtual camera, where the game image includes a virtual object, and the method includes:
in response to a configuration trigger operation for the virtual object, shortening a distance between the virtual camera and the virtual object, and displaying a function control for configuring the virtual object; and
configuring content corresponding to the function control for the virtual object in response to a selection operation for the function control.

In some embodiments, the content corresponding to the function control includes at least one of the following: a skill, equipment or a skin.

In some embodiments, the method for displaying the game interface further includes:
controlling the virtual camera to rotate a preset angle towards a preset direction in response to the configuration trigger operation for the virtual object.

In some embodiments, the method for displaying the game interface further includes:
displaying a target layer in response to the configuration trigger operation for the virtual object, where the function control is located on the target layer, and the target layer is transparent.

In some embodiments, before in response to the configuration trigger operation for the virtual object, the graphical user interface further includes first interface information, and the method for displaying the game interface further includes:
hiding the first interface information in response to the configuration trigger operation for the virtual object.

In some embodiments, while the displaying the function control for configuring the virtual object, the method further includes: displaying a return control;
after the displaying the function control for configuring the virtual object, the method further includes:
hiding the function control and lengthening the distance between the virtual camera and the virtual object in response to a trigger operation for the return control.

In some embodiments, while the displaying the function control for configuring the virtual object, the method further includes: displaying a return control;
after the displaying the function control for configuring the virtual object, the method further includes:
hiding the function control in response to a trigger operation for the return control;
lengthening the distance between the virtual camera and the virtual object, and controlling the virtual camera to rotate a preset angle towards a direction opposite to the preset direction.

In some embodiments, after the configuring the content corresponding to the function control for the virtual object, the method further includes:
displaying second interface information on the graphical user interface in response to a configuration completion operation for the virtual object, where the second interface information includes configured content information of the virtual object.

According to another aspect, embodiments of the present disclosure provide an apparatus for displaying a game interface, where a graphical user interface is provided by a terminal device, the graphical user interface includes a game image captured by a virtual camera, where the game image includes a virtual object, and the apparatus includes:
a control unit, configured to in response to a configuration trigger operation for the virtual object, shorten a distance between the virtual camera and the virtual object, and display a function control for configuring the virtual object; and
a configuration unit, configured to configure content corresponding to the function control for the virtual object in response to a selection operation for the function control.

In some embodiments, the content corresponding to the function control includes at least one of the following: a skill, equipment or a skin.

In some embodiments, the control unit is further configured to:
in response to the configuration trigger operation for the virtual object, control the virtual camera to rotate a preset angle towards a preset direction.

In some embodiments, the control unit is further configured to:
in response to the configuration trigger operation for the virtual object, display a target layer, where the function control is located on the target layer, and the target layer is transparent.

In some embodiments, the graphical user interface also includes first interface information before the control unit responds to the configuration trigger operation for the virtual object;
the apparatus for displaying the game interface provided by the embodiments of the present disclosure also includes:
a hiding unit, configured to hide the first interface information in response to the configuration trigger operation for the virtual object.

In some embodiments, the control unit is further configured to display a return control while displaying the function control for configuring the virtual object;
the apparatus for displaying the game interface provided by the embodiments of the present disclosure also includes:
a first return unit, configured to, after the control unit displays the function control for configuring the virtual object, in response to a trigger operation for the return control, hide the function control and lengthen the distance between the virtual camera and the virtual object.

In some embodiments, the control unit is also configured to display a return control while displaying the function control for configuring the virtual object;
the apparatus for displaying the game interface provided by the embodiments of the present disclosure further includes:
a second return unit, configured to, after the control unit displays the function control for configuring the virtual object, in response to a trigger operation for the return control, hide the function control; lengthen the distance between the virtual camera and the virtual object, and control the virtual camera to rotate a preset angle towards a direction opposite to the preset direction.

In some embodiments, the apparatus for displaying the game interface provided by the embodiments of the present disclosure also includes:
a display unit, configured to, after the configuration unit configures the content corresponding to the function control for the virtual object, in response to a configuration completion operation for the virtual object, display second interface information on the graphical user interface, where the second interface information includes configured content information of the virtual object

According to another aspect, embodiments of the present disclosure provide a terminal device, including a memory, a processor and a computer program stored on the memory and executable by the processor, when the computer program is executed by the processor, the processor implements the method for displaying the game interface according to the embodiments of the present disclosure.

According to another aspect, embodiments of the present disclosure provide a non-transitory computer-readable storage medium, where the computer-readable storage medium stores computer instructions, and the computer instructions, when executed by a processor, implement the method for displaying the game interface according to the embodiments of the present disclosure.

Those skilled in the art may make various modifications and variations to the disclosed embodiments without departing from the spirit and scope of the disclosed embodiments. Thus, if these modifications and variations of the embodiments of the present disclosure are within the scope of the claims of the present disclosure and their equivalents, the present disclosure is also intended to include these modifications and variations.

1. A method for displaying a game interface, comprising:
in response to a configuration trigger operation for a virtual object, shortening a distance between a virtual camera and the virtual object, and displaying a function control for configuring the virtual object; wherein a graphical user interface is provided by a terminal device, the graphical user interface comprises a game image captured by the virtual camera, and the game image comprises the virtual object; and
configuring content corresponding to the function control for the virtual object in response to a selection operation for the function control.

2. The method according to claim 1, wherein the content corresponding to the function control comprises at least one of the following: a skill, equipment or a skin.

3. The method according to claim 1, further comprising:
controlling the virtual camera to rotate a preset angle towards a preset direction in response to the configuration trigger operation for the virtual object.

4. The method according to claim 1, further comprising:
displaying a target layer in response to the configuration trigger operation for the virtual object, wherein the function control is located on the target layer, and the target layer is transparent.

5. The method according to claim 1, wherein the graphical user interface further comprises first interface information, and the method further comprises:
hiding the first interface information in response to the configuration trigger operation for the virtual object.

6. The method according to claim 1, wherein the method further comprises:
displaying a return control;
hiding the function control and lengthening the distance between the virtual camera and the virtual object in response to a trigger operation for the return control.

7. The method according to claim 3, wherein the method further comprises:
displaying a return control;
hiding the function control in response to a trigger operation for the return control;
lengthening the distance between the virtual camera and the virtual object, and controlling the virtual camera to rotate a preset angle towards a direction opposite to the preset direction.

8. The method according to claim 1, wherein the method further comprises:
displaying second interface information on the graphical user interface in response to a configuration completion operation for the virtual object, wherein the second interface information comprises configured content information of the virtual object.

9-11. (canceled)

12. The method according to claim 5, wherein the first interface information comprises at least one of the following: a virtual object control, a virtual object configuration control, current configuration information and object introduction information of the virtual object.

13. The method according to claim 4, wherein the virtual object is located on the target layer.

14. The method according to claim 4, wherein the virtual object is not located on the target layer.

15. The method according to claim 4, wherein the target layer covers the game image.

16. A terminal device, comprising a memory, a processor and a computer program stored on the memory and executable by the processor, when the computer program is executed by the processor, the processor is configured to:
provide a graphical user interface, wherein the graphical user interface comprises a game image captured by a virtual camera, wherein the game image comprises a virtual object;
in response to a configuration trigger operation for the virtual object, shorten a distance between the virtual camera and the virtual object, and display a function control for configuring the virtual object; and
configure content corresponding to the function control for the virtual object in response to a selection operation for the function control.

17. The terminal device according to claim 16, wherein the content corresponding to the function control comprises at least one of the following: a skill, equipment or a skin.

18. The terminal device according to claim 16, wherein the processor is further configured to:
control the virtual camera to rotate a preset angle towards a preset direction in response to the configuration trigger operation for the virtual object.

19. The terminal device according to claim 16, wherein the processor is further configured to:
display a target layer in response to the configuration trigger operation for the virtual object, wherein the function control is located on the target layer, and the target layer is transparent.

20. The terminal device according to claim 16, wherein the graphical user interface further comprises first interface information, and the processor is further configured to:
hide the first interface information in response to the configuration trigger operation for the virtual object.

21. The terminal device according to claim 16, wherein the processor is further configured to
display a return control; and
hide the function control and lengthening the distance between the virtual camera and the virtual object in response to a trigger operation for the return control.

22. The terminal device according to claim 18, wherein the processor is further configured to display a return control;
hide the function control in response to a trigger operation for the return control;
lengthen the distance between the virtual camera and the virtual object, and control the virtual camera to rotate a preset angle towards a direction opposite to the preset direction.

23. A non-transitory computer-readable storage medium, wherein the computer-readable storage medium stores computer instructions, and the computer instructions, when executed by a processor, cause the process to:
in response to a configuration trigger operation for the virtual object, shorten a distance between a virtual camera and a virtual object, and display a function control for configuring the virtual object; and
configure content corresponding to the function control for the virtual object in response to a selection operation for the function control.
